(19) United States
(12) Patent Application Publication
(10) Pub. No.: US 2015/0026017 A1
(43) Pub. Date: Jan. 22, 2015

(54) INFORMATION PROCESSING APPARATUS AND INFORMATION PROCESSING METHOD

(71) Applicant: TOSHIBA TEC KABUSHIKI KAISHA, Tokyo (JP)

(72) Inventor: Youji Tsunoda, Izunokuni-shi (JP)

(21) Appl. No.: 14/332,778

(22) Filed: Jul. 16, 2014

(30) Foreign Application Priority Data
Jul. 16, 2013 (JP) 2013-147900
Apr. 11, 2014 (JP) 2014-082273

(51) Int. Cl. G06Q 30/06

(52) U.S. Cl. CPC G06Q 30/0643
USPC 705/27.2

(57) ABSTRACT

In accordance with one embodiment, an information processing apparatus comprises an image capturing module configured to photograph a commodity to capture the image of the commodity, an extraction module configured to extract a feature amount from the image captured by the image capturing module; a calculation module configured to compare the feature amount of each commodity registered in a dictionary with the feature amount of the commodity extracted by the extraction module to calculate a similarity degree therebetween; a recognition module configured to recognize a commodity of which the similarity degree is greater than a threshold value as a commodity candidate within the commodities registered in the dictionary; and a display control module configured to switch information representing the commodity candidates according to the number of the commodity candidates recognized by the recognition module to display it.

### CROSS-REFERENCE TO RELATED APPLICATION

The present application is based upon and claims the benefit of priorities from Japanese Patent Application No. 2013-147900 filed on Jul. 16, 2013 and Japanese Patent Application No. 2014-082273 filed on Apr. 11, 2014, the entire contents of which are hereby incorporated by reference.

### FIELD

Embodiments described herein relate to an information processing apparatus and an information processing method.

### BACKGROUND

Conventionally, there is a technology in which the feature amount of an object from image data obtained by photographing the object is extracted and the extracted feature amount is compared with the prepared data indicating the feature amount of an object for comparison to recognize the category of the object. Moreover, a store system in which the above technology is used for recognizing (identifying) a commodity such as vegetables and fruits to register the sales of the recognized commodity is proposed. In such store system, if there is a plurality of commodities (commodity for comparison) recognized as candidate of a commodity, these commodity candidates are displayed in a selectable manner, and selection by a user is received.

In the meantime, in the conventional store system described above, number of the commodity candidates is not taken into consideration to display them, and the commodity candidates are displayed within a fixed number of frames on a screen. However, in such a constitution, it is difficult to cope with a case in which commodity candidates the number of which are more than that of the frames are recognized, and thus it is inconvenient for an operator.

### BRIEF DESCRIPTION OF THE DRAWINGS

FIG. 1 is a perspective view illustrating an external constitution of a checkout system including a POS terminal and a commodity reading apparatus according to an embodiment;

FIG. 2 is a block diagram illustrating hardware constitution of the POS terminal and the commodity reading apparatus shown in FIG. 1;

FIG. 3 is a diagram schematically illustrating one example of data constitution of a PLU file shown in FIG. 2;

FIG. 4 is a diagram schematically illustrating one example of data constitution of a group setting file shown in FIG. 2;

FIG. 5 is a block diagram illustrating functional components of the POS terminal and the commodity reading apparatus shown in FIG. 1;

FIG. 6 is a diagram illustrating an example of the display of a commodity candidate screen;

FIG. 7 is a diagram illustrating an example of the display of a commodity candidate screen;

FIG. 8 is a diagram illustrating an example of the display of a commodity candidate screen;

FIG. 9 is a diagram illustrating an example of the display of update information;

FIG. 10 is a flowchart illustrating a procedure of a commodity recognition processing executed by the commodity reading apparatus;

FIG. 11 is a flowchart illustrating a procedure of a sales registration processing executed by the POS terminal;

FIG. 12 is a perspective view illustrating the external constitution of a self-checkout POS terminal according to the embodiment; and

FIG. 13 is a block diagram illustrating hardware constitution of the self-checkout POS terminal shown in FIG. 12.

### DETAILED DESCRIPTION

In accordance with one embodiment, an information processing apparatus comprises an image capturing module, an extraction module, a calculation module, a recognition module and a display control module. The image capturing module photographs a commodity to capture the image of the commodity. The extraction module extracts a feature amount from the image captured by the image capturing module. The calculation module compares the feature amount of each commodity registered in a dictionary with the feature amount of the commodity extracted by the extraction module to calculate a similarity degree therebetween. The recognition module recognizes a commodity of which the similarity degree is greater than a threshold value as a commodity candidate within the commodities registered in the dictionary. The display control module switches information representing the commodity candidates according to the number of the commodity candidates recognized by the recognition module to display it.

Hereinafter, taking a checkout system as an example, an information processing apparatus and program according to the present embodiment are described with reference to the accompanying drawings. A store system is a checkout system (POS system) comprising a POS terminal for registering and settling commodities in one transaction. The present embodiment is an example of application to a checkout system introduced to a store such as a supermarket and the like.

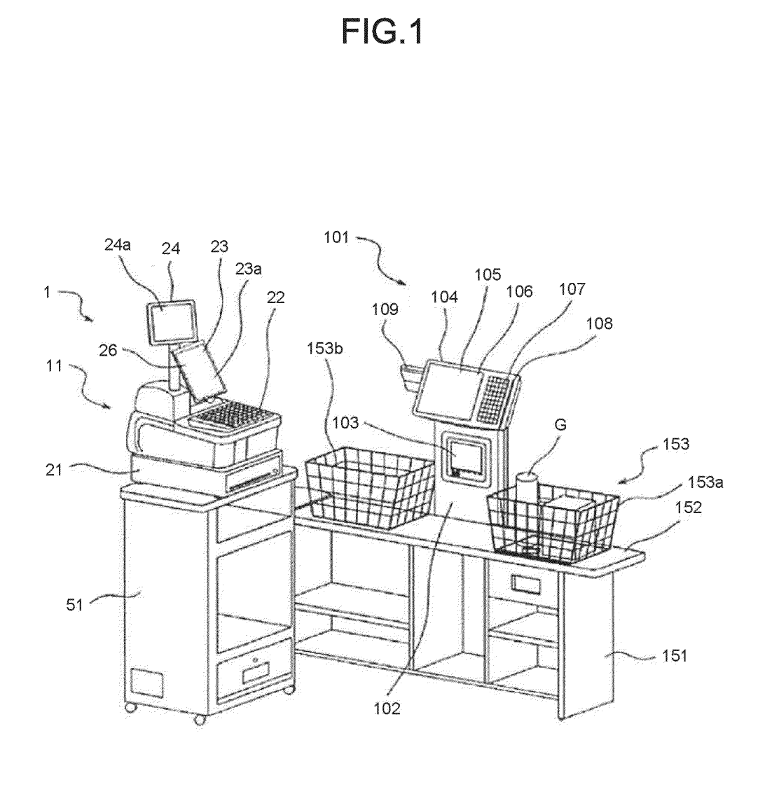

FIG. 1 is a perspective view illustrating an external constitution of a checkout system 1. As shown in FIG. 1, the checkout system 1 comprises a POS terminal 11 and a commodity reading apparatus 101 serving as an information processing apparatus.

The POS terminal 11 is placed on a drawer 21 on a checkout counter 51. The drawer 21 is opened or closed under the control of the POS terminal 11. A keyboard 22 is arranged on the upper surface of the POS terminal 11 for an operator (shop clerk) who operates the POS terminal 11. A display device 23 for displaying information to the operator is arranged at a position opposite to the operator with respect to the keyboard 22. The display device 23 displays information on a display screen 23a thereof. A touch panel 26 is laminated on the display screen 23a. A display for customer 24 is vertically arranged to be rotatable at a backside to the display device 23. The display for customer 24 displays information on a display screen 24a thereof.

The display for customer 24 shown in FIG. 1 is in a state in which the display screen 24a thereof faces the operator in FIG. 1, however, the display for customer 24 can be rotated such that the display screen 24a is directed to a customer to display information to the customer.

A horizontally elongated counter table 151 is arranged to be in an L-shape with the checkout counter 51 on which the POS terminal 11 is placed. A commodity receiving surface 152 is formed on the counter table 151. Shopping basket 153 which receives a commodity G therein is placed on the commodity receiving surface 152. It can be understood to classify the shopping basket 153 on the counter table 151 into a first shopping basket 153a brought to the counter table 151 by a customer and a second shopping basket 153b placed facing the first shopping basket 153a across the commodity reading apparatus 101.

The commodity reading apparatus 101, which is connected with the POS terminal 11 to be capable of sending and receiving data, is arranged on the commodity receiving surface 152 of the counter table 151. The commodity reading apparatus 101 comprises a thin rectangular housing 102.

A reading window 103 is arranged at the front side of the housing 102. A display and operation section 104 is installed on the upper portion of the housing 102. A display device 106 such as a liquid crystal display device on the surface of which a touch panel 105 is laminated is arranged on the display and operation section 104. A keyboard 107 is arranged at the right side of the display device 106. A card reading slot 108 of a card reader (not shown) is arranged at the right side of the keyboard 107. A display for customer 109 is arranged at the left side of the display and operation section 104.

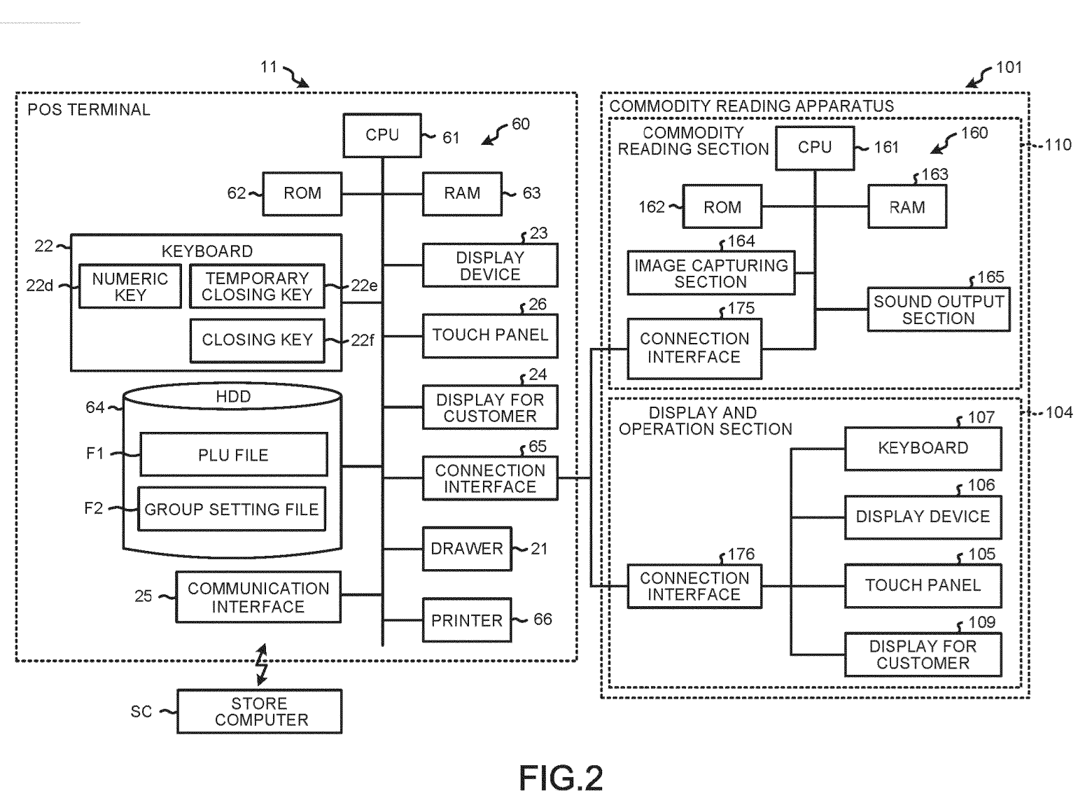

Commodities G purchased in one transaction are put in the first shopping basket 153a and are brought to the counter table 151 by a customer. The commodities G in the first shopping basket 153a are moved one by one to the second shopping basket 153b by the operator who operates the commodity reading apparatus 101. During the movement, the commodity G is directed to the reading window 103 of the commodity reading apparatus 101. At this time, an image capturing section 164 (refer to FIG. 2) arranged in the reading window 103 captures an image of the commodity G.

FIG. 2 is a block diagram illustrating the hardware constitution of the POS terminal 11 and the commodity reading apparatus 101.

The POS terminal 11 includes a microcomputer 60 serving as an information processing section for executing information processing. The microcomputer 60 comprises a CPU (Central Processing Unit) 61 which executes various arithmetic processing and controls each section, a ROM (Read Only Memory) 62 and a RAM (RandomAccess Memory) 63. The ROM 62 stores programs executed by the CPU 61.

The drawer 21, the keyboard 22, the display device 23, the display for customer 24, a communication interface 25, the touch panel 26, an HDD (Hard Disk Drive) 64, a connection interface 65 and a receipt printer 66 are all connected with the CPU 61 of the POS terminal 11 via various input/output circuits (not shown).

The keyboard 22 includes numeric keys 22d on which numeric characters such as ‘1’, ‘2’, ‘3’ and operators such as multiplying operator ‘*’ are displayed, a temporary closing key 22e and a closing key 22f.

The HDD 64 stores various programs and files. When the POS terminal 11 is started, the programs stored in the HDD 64 are all or partially developed on the RAM 63 and executed by the CPU 61.

The HDD 64 also stores data files such as a PLU file F1, a group setting file F2 and the like. The PLU file F1 and the group setting file F2 are readable from the commodity reading apparatus 101 via the connection interface 65.

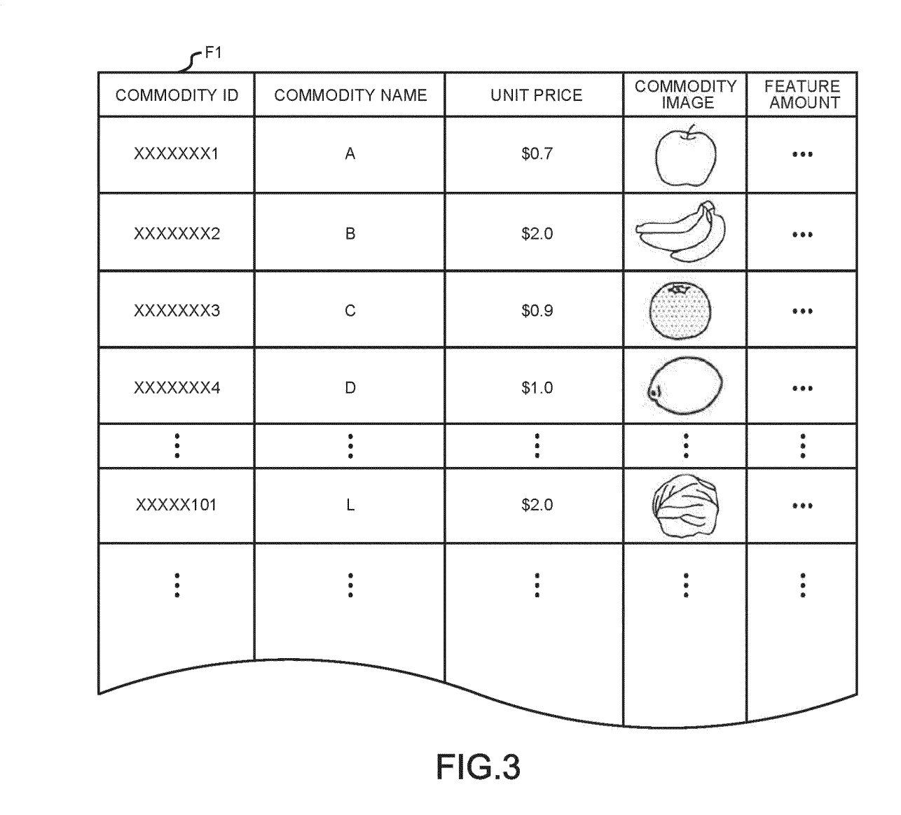

The PLU file F1 is a data file in which a commodity G sold in the store is associated with information relating to the sales registration of the commodity G. FIG. 3 is a diagram schematically illustrating an example of the data arrangement of the PLU file F1. As shown in FIG. 3, a commodity ID uniquely assigned to each commodity G, information relating to a commodity such as a commodity name and a unit price, and a commodity image captured by photographing the commodity G, for each commodity are registered in association with one another in the PLU file F1. Further, in the PLU file F1, appearance feature amount of the commodity G (feature amount data of a commodity registered in a dictionary) is also registered in association with each commodity G. In the present embodiment, the feature amount data of the PLU file F1 functions as a dictionary (dictionary data). The present invention is not limited to the embodiment, and the dictionary data may be arranged separately from the PLU file F1. In this case, the dictionary data and other data in the PLU file are associated with each other for the same commodity.

The commodity image is captured by photographing each commodity, which is registered in a dictionary and is used as a reference at the time of similarity degree determination described later. The commodity image is indicated as an image showing the commodity candidate at the time of indication of a commodity candidate described later. Further, the feature amount of a commodity G previously extracted from the captured image (for example, a commodity image) of each commodity G is registered in association with a corresponding commodity ID. The feature amount refers to information representing the feature of the commodity G such as the hue, pattern, concave-convex state, shape and the like of the surface of a commodity G.

In the present embodiment, the feature amount of each commodity G is registered in the PLU file F1 in advance, however, it is not limited to this, and the feature amount may be not registered. In this case, the feature amount may be extracted as needed from each commodity image by a feature amount extraction section 1613 described later to obtain the feature amount. Further, instead of a commodity image, an image for indication may also be registered. Hereinafter, each commodity registered in the PLU file F1 is referred to as a registration commodity.

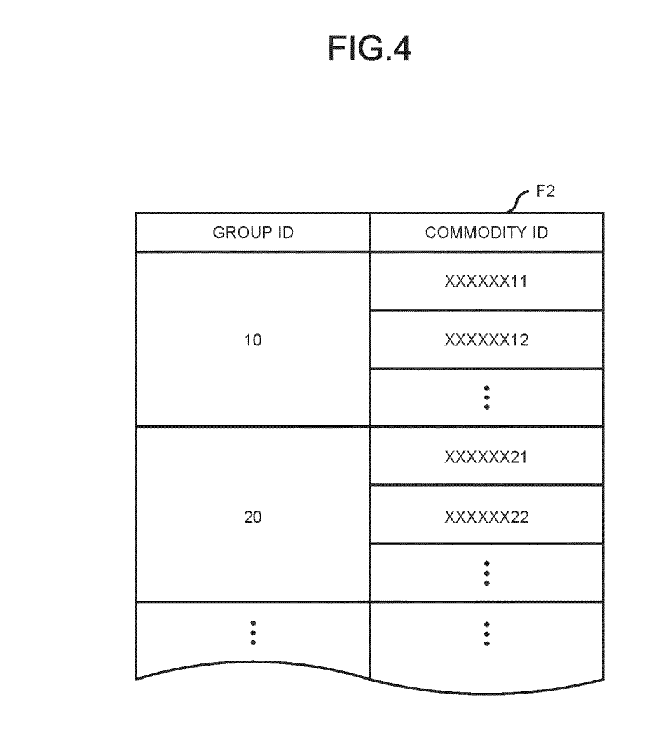

The group setting file F2 is a data file for managing the registration commodities belonging to the same group. FIG. 4 is a diagram schematically illustrating one example of data arrangement of the group setting file F2. As shown in FIG. 4, a group ID uniquely assigned to each group and a commodity ID of each registration commodity belonging to the same group are registered in the group setting file F2 in association with each other.

No specific limitation is given to the combination of the registration commodities as the same group. For example, in a case in which there is a plurality of sales forms for one commodity, the commodity ID assigned to each sales form may be classified into the same group. In this case, for example, the same commodity sold at one unit or sold at ½ or ¼ unit may be classified into the same group. Further, the commodity IDs of the registration commodities belonging to the same category or type may be classified into the same group. In this case, for example, varieties, which respectively have different appearances or different taste, belonging to the same category having a name of “apple” maybe classified into the same group. Even for the different registration commodities, the registration commodities similar in appearance feature to one another may be classified into the same group. In this case, for example, if there is a possibility that the registration commodities are recognized incorrectly in the commodity candidate recognition described later, such registration commodities may be classified into the same group.

Returning to FIG. 2, the communication interface 25 for executing data communication with a store computer SC is connected with the CPU 61 of the POS terminal 11 through the input/output circuit (not shown). The store computer SC is arranged at a backyard and the like in a store. The HDD (not shown) of the store computer SC stores the PLU file F1 and the group setting file F2 sent to the POS terminal 11, and a stock management file for managing the stock state of each registration commodity in the PLU file F1.

The connection interface 65 enables the data transmission/reception with the commodity reading apparatus 101. The commodity reading apparatus 101 is connected with the connection interface 65. A receipt printer 66 is provided in the POS terminal 11. The POS terminal 11 prints content of one transaction on a receipt with the receipt printer 66 under the control of the CPU 61.

The commodity reading apparatus 101 comprises a commodity reading section 110 and a display and operation section 104. The commodity reading section 110 includes a microcomputer 160. The microcomputer 160 comprises a CPU 161, a ROM 162 and a RAM 163. The ROM 162 stores programs executed by the CPU 161.

The image capturing section 164, a sound output section 165 and a connection interface 175 are connected with the CPU 161 through various input/output circuits (not shown). Operations of the image capturing section 164, the sound output section 165 and the connection interface 175 are controlled by the CPU 161.

The image capturing section 164, which is a color CCD sensor or a color CMOS sensor and the like, is an image capturing module for carrying out an image capturing processing through the reading window 103. For example, motion images are captured by the image capturing section 164 at 30 fps. The frame images (captured images) sequentially captured by the image capturing section 164 at a given frame rate are stored in the RAM 163. The sound output section 165 includes, for example, a sound circuit and a speaker for generating a preset alarm sound and the like. The sound output section 165 gives a notification through a sound such as an alarm sound under the control of the CPU 161.

The display and operation section 104 comprises the touch panel 105, the display device 106, the keyboard 107, the display for customer 109 and a connection interface 176. The connection interface 175 of the commodity reading section 110, which is connected with the connection interface 65 of the POS terminal 11, enables the data transmission/reception with the POS terminal 11. The connection interface 175 connects with the display and operation section 104 through the connection interface 176, and the CPU 161 carries out data transmission/reception between the commodity reading section 110 and the display and operation section 104 through the connection interface 175.

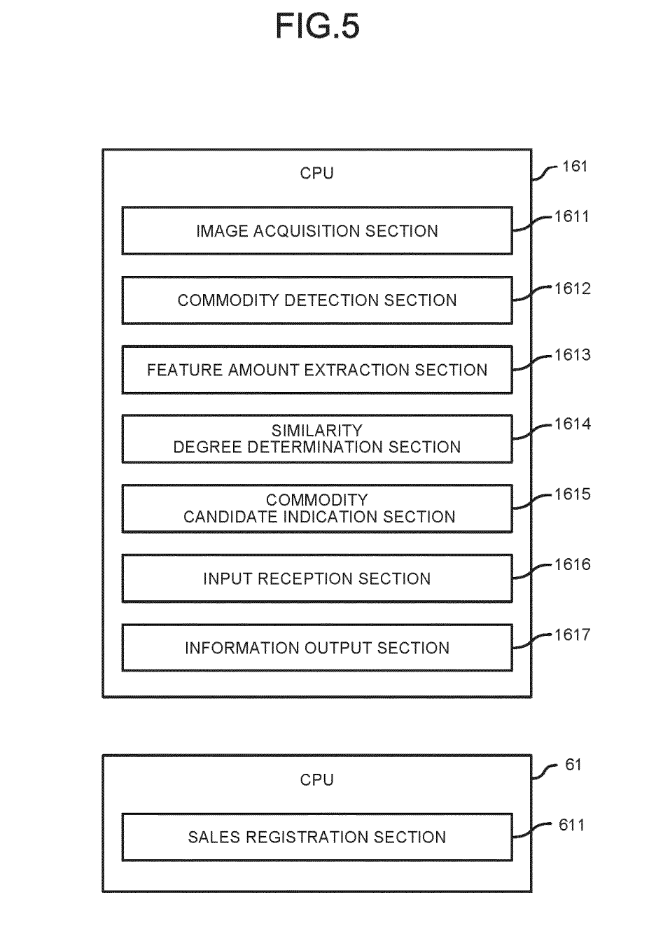

Next, the functional components of the CPU 161 and the CPU 61 realized by executing the programs by the CPU 161 and, the CPU 61 are described below with reference to FIG. 5.

FIG. 5 is a block diagram illustrating the functional components of the POS terminal 11 and the commodity reading apparatus 101. As shown in FIG. 5, the CPU 161 of the commodity reading apparatus 101 executes programs sequentially to function as an image acquisition section 1611, a commodity detection section 1612, a feature amount extraction section 1613, a similarity degree determination section 1614, a commodity candidate indication section 1615, an input reception section 1616 and an information output section 1617.

The image acquisition section 1611 is a functional section corresponding to an acquisition module. The image acquisition section 1611 outputs an ON-signal of image capturing to the image capturing section 164 to enable the image capturing section 164 to start an image capturing operation to a commodity G. The image acquisition section 1611 sequentially acquires the captured images which are captured by the image capturing section 164 and are stored in the RAM 163 after the image capturing operation starts. The image acquisition section 1611 acquires the captured images from the RAM 163 in the order of storing them to the RAM 163.

The commodity detection section 1612 is a functional section corresponding to a detection module. The commodity detection section 1612 detects the whole or part of the contour line of the commodity G contained in the captured image acquired by the image acquisition section 1611 using a known pattern matching technology. Next, by comparing the contour line extracted from the last time captured image (frame image) with the contour line extracted from the current frame image (next to the last time), a different part, that is, a reflection image area of the commodity G directed to the reading window 103 is detected.

As another method for detecting a commodity G, it is determined whether or not a flesh color area is detected from the captured image. If the flesh color area is detected, that is, the reflection image of the hand of a shop clerk is detected, the detection of the aforementioned contour line nearby the flesh color area is carried out to try to extract the contour line of the commodity G that is assumed to be held by the shop clerk. At this time, if a contour line indicating the shape of a hand and the contour line of an object other than the hand nearby the contour line of the hand are detected, the commodity G is detected from the contour line of the object.

The feature amount extraction section 1613 is a functional section corresponding to an extraction module. The feature amount extraction section 1613 extracts the surface state (surface hue, pattern, concave-convex state, shape and the like) of the commodity G detected by the commodity detection section 1612 from the captured image acquired by the image acquisition section 1611 as a feature amount.

The similarity degree determination section 1614 is a functional section corresponding to a calculation module and a recognition module. The similarity degree determination section 1614 compares the feature amount of each registration commodity in the PLU file F1 of the POS terminal 11 with the feature amount extracted by the feature amount extraction section 1613 to calculate the similarity degree therebetween. Further, the similarity degree determination section 1614 recognizes, in the registration commodities the similarity degrees of which are calculated, the registration commodity (commodity ID) of which the similarity degree is greater than a given threshold value as a candidate (commodity candidate) of the commodity G photographed by the image capturing section 164. The similarity degree determination section 1614 specifies the registration commodity which belongs to the same group as the recognized commodity candidate from the group setting file F2 and recognizes the registration commodity as the commodity candidate.

The similarity degree may be a value (similarity degree), which is obtained by comparing the feature amount of the commodity G with the feature amount of each commodity registered in the PLU file F1, representing how much similar the two feature amounts are. The concept of the similarity degree is not limited to the example above. The similarity degree may be a value representing the degree of coincidence with the feature amount of each registration commodity in the PLU file F1, or a value representing the degree of correlation between the feature amount of the commodity G and the feature amount of each registration commodity in the PLU file F1.

The recognition of an object contained in an image as stated above is referred to as a general object recognition. As to the general object recognition, various recognition technologies are described in the following document.

Keiji Yanai “Present situation and future of generic object recognition”, Journal of Information Processing Society, Vol. 48, No. SIG16 [Search on Heisei 25 January 24], Internet<URL: http://mm.cs.uec.ac.jp/IPSJ-TCVIM-Yanai.pdf>

In addition, the technology carrying out the general object recognition by performing an area-division on the image for each object is described in the following document.

Jamie Shotton etc, “Semantic Texton Forests for Image Categorization and Segmentation”, [Search on Heisei 25 January 24], Internet <URL: http://citeseerx.ist.psu.edu/viewdoc/download?doi=10.1.1.145.3036&rep=repl&type=pdf>

It is noted that no limitation is given to the method for calculating the similarity degree. For example, the similarity degree can be calculated as an absolute evaluation or a relative evaluation. If the similarity degree is calculated as an absolute evaluation, the captured image of the commodity G and each of the registered commodities are compared one by one, and the similarity degree obtained from the comparison result can be adopted as it is. If the similarity degree is calculated as a relative evaluation, the similarity degree is obtained as long as the sum of the similarity degrees between the captured commodity G and each registration commodity becomes 1.0 (100%).

The commodity candidate indication section 1615 is a functional section corresponding to a selection module and a display control module. The commodity candidate indication section 1615 displays information relating to the registration commodity recognized as a commodity candidate by the similarity degree determination section 1614 on the display device 106. More specifically, the commodity candidate indication section 1615 reads the record of the registration commodity recognized as a commodity candidate from the PLU file F1, and displays it on the commodity candidate screen of the display device 106.

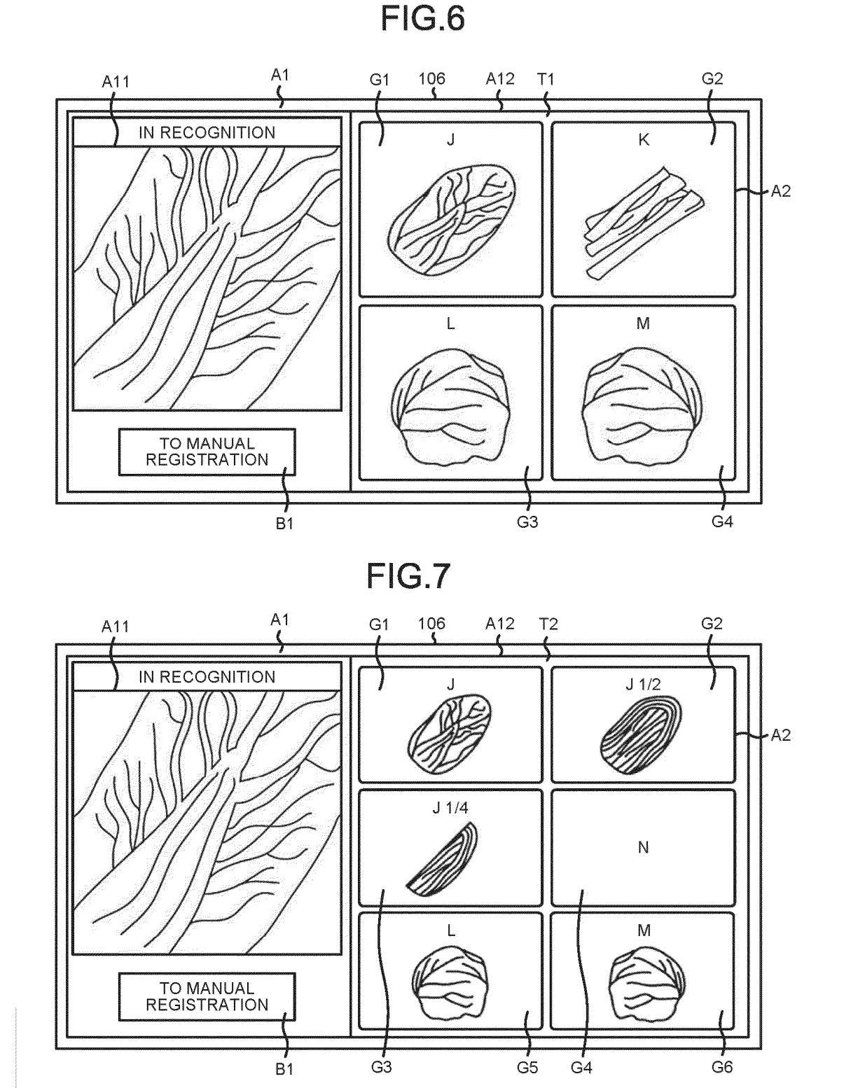

FIG. 6-FIG. 8 are diagrams illustrating an example of the display of a commodity candidate screen. A commodity candidate screen A1 displayed on the display device 106 includes a captured image area A11 and a commodity candidate indication area A12.

The captured image area A11 is used for displaying the captured image acquired by the image acquisition section 1611. A manual registration button B1 is provided at an area below the captured image area A11 to instruct the commodity recognition (registration) which is carried out by manually designating a category code or a commodity list. The CPU 161 displays on the display device 106 a manual registration screen (not shown) which is used to manually carry out the recognition (registration) of a commodity G in response to the operation of the manual registration button B1. The commodity designated through the manual registration screen is processed as a determined commodity described later.

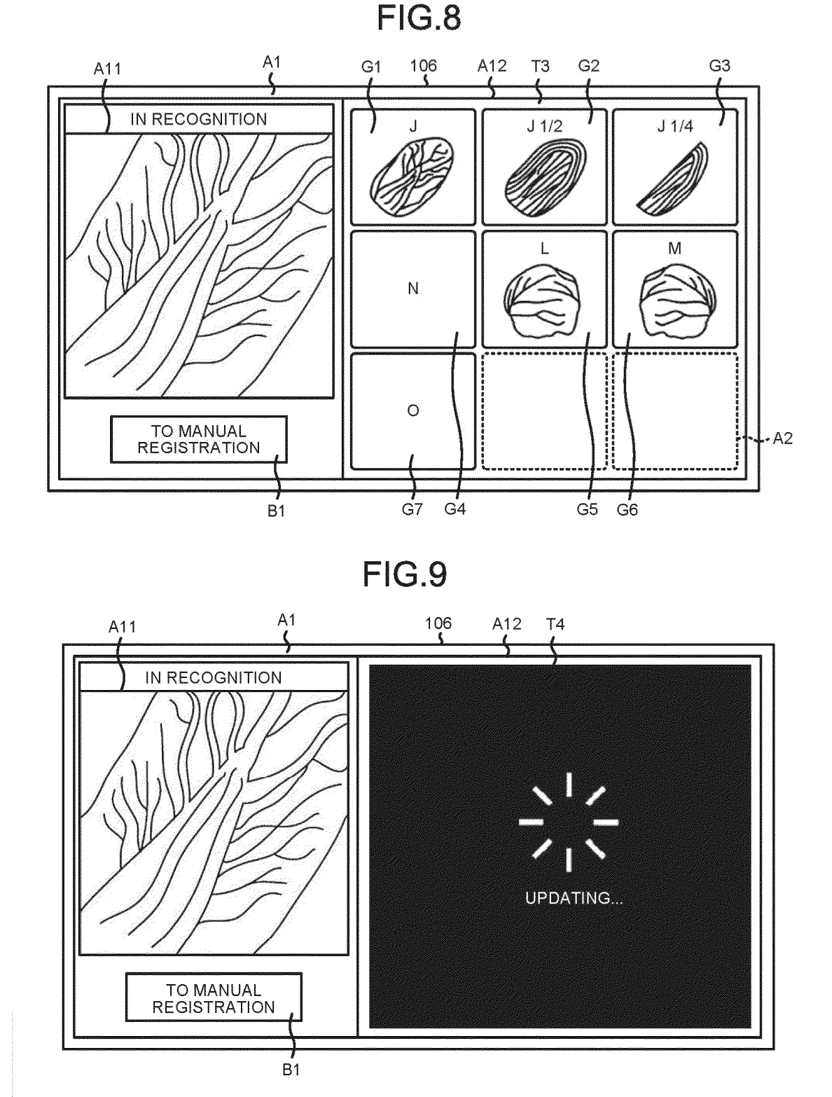

The commodity candidate indication area A12 is used for displaying information relating to a registration commodity recognized as a commodity candidate. As shown in FIG. 6-FIG. 8, one of templates T1-T3 respectively including different numbers of arrangement areas A2 is set in the commodity candidate indication area A12. In the present embodiment, the template T1 (refer to FIG. 6) includes four arrangement areas A2. The template T2 (refer to FIG. 7) includes six arrangement areas A2. The template T3 (refer to FIG. 8) includes nine arrangement areas A2. The number of the templates is not limited as long as it is more than one, and it may be more than four.

The commodity candidate indication section 1615 selects a template corresponding to the number of commodity candidates from the templates T1-T3 and sets it in the captured image area A11. In a case in which the number of the commodity candidates changes (increases), the template is switched and set according to the number thereof. The commodity candidate indication section 1615 arranges and displays information (G1-G7) such as the commodity image and the commodity name of the commodity candidate in the arrangement areas A2 of the template. The commodity candidates displayed in the commodity candidate indication area A12 can be selected through a touch operation on the touch panel 105.

For example, if the number of the commodity candidates is equal to or less than four, the template T1 (refer to FIG. 6) is selected to display commodity images. If the number of the commodity candidates recognized by the similarity degree determination section 1614 is equal to or more than five, the template is switched to the template T2 (refer to FIG. 7) to display the commodity images. Further, if the number of the commodity candidates recognized by the similarity degree determination section 1614 is equal to or more than seven, the template is switched to the template T3 (refer to FIG. 8) to display the commodity images.

FIG. 8 shows the commodity candidate indication area A12 to which the template T3 having nine arrangement areas A2 is set and thus the commodity candidate indication area A12 is capable of displaying nine commodity candidates at most. In the example shown in FIG. 8, seven commodity candidates are displayed.

In this way, the commodity candidate indication section 1615 switches information representing the commodity candidates according to the number of the recognized commodity candidates to display it. The commodity candidate indication section 1615 switches a template to another template having more arrangement areas in a step manner as the number of the commodity candidates increases. Therefore, even in a case in which a plurality of commodity candidates is recognized, the commodity candidates can be displayed in a layout corresponding to the number of the commodity candidates, which can improve convenience in the display of the commodity candidates.

No specific limitation is given to the arrangement order of the commodity candidates, and thus, for example, the commodity candidates may be arranged or displayed in the descending order of similarity degree of the registration commodities. In the present embodiment, in a case in which the number of the commodity candidates is equal to or more than ten, nine commodity candidates are further extracted from these commodity candidates and arranged in the template T3. At this time, for example, the nine commodity candidates earlier recognized may be selected, alternatively, the nine commodity candidates with higher similarity degree may be extracted. In the commodity candidate indication area A12, it is applicable to display only the commodity names of the commodity candidates recognized by the similarity degree determination section 1614 without displaying the commodity images.

Following to the above, an operator of the commodity reading apparatus 101 selects a commodity candidate applicable to the commodity G from the commodity candidates respectively displayed in the commodity candidate indication area A12. However, if the switching of the template is carried out at the timing at which the operator selects the commodity candidate, there is a possibility that the operator cannot select the desired commodity candidate due to the change of the layout. Thus, the commodity candidate indication section 1615 displays, if the template is switched, update information for notifying that the template (commodity candidates) is being updated in the commodity candidate indication area A12.

FIG. 9 is a diagram illustrating an example of the display of the update information. As shown in FIG. 9, the commodity candidate indication section 1615 displays update information T4 in the commodity candidate indication area A12 if the template is changed. It is noted that no specific limitation is given to the time of continuing the display of the update information T4, but it is preferred to set a time (for example, two seconds) long enough for the operator to recognize that the template is being updated. The display of the update information T4 may be carried out by, for example, displaying a message of “updating” with a background in black color. Further, it is also preferred to carry out a control so that the commodity candidates cannot be selected while the display of the update information T4 is continued.

In this way, the occurrence of incorrect operation caused by the switching of the template can be reduced, which can improve the convenience in the display of the commodity candidates and also improve the operability for selecting the commodity candidate by the operator. The update information may also be displayed when the commodity candidate indication area A12 (template) is displayed for the first time.

Returning to FIG. 5, the input reception section 1616 receives various input operations corresponding to the display of the display device 106 through the touch panel 105 or the keyboard 107. For example, the input reception section 1616 receives a selection operation of one commodity candidate from the commodity candidates displayed on the display device 106. The input reception section 1616 receives the selected commodity candidate as the commodity (determined commodity) corresponding to the commodity G photographed by the image capturing section 164. In a case in which the commodity detection section 1612 has a capability of detecting a plurality of commodities G, the input reception section 1616 may receive selection operations of a plurality of commodity candidates from the commodity candidates.

The information output section 1617 outputs information (for example, the commodity ID, the commodity name and the like) indicating the commodity determined in the aforementioned manner to the POS terminal 11 through the connection interface 175.

The information output section 1617 may also output the sales volume input separately through the touch panel 105 or the keyboard 107 to the POS terminal 11 together with the commodity ID and the like. As to information output to the POS terminal 11 by the information output section 1617, the information output section 1617 may directly notify of the commodity ID read from the PLU file F1, or the commodity name capable of specifying the commodity ID and file name of the commodity image may be notified, or the storage location of the commodity ID (storage address in the PLU file F1) may be notified.

On the other hand, the CPU 61 of the POS terminal 11 has a function of a sales registration section 611 by executing programs. The sales registration section 611 carries out a sales registration of a corresponding commodity based on the commodity ID and the sales volume output from the information output section 1617 of the commodity reading apparatus 101. Specifically, the sales registration section 611 carries out, with reference to the PLU file F1, a sales registration by recording the notified commodity ID and the commodity category, commodity name and unit price specified with the commodity ID in a sales master file together with the sales volume.

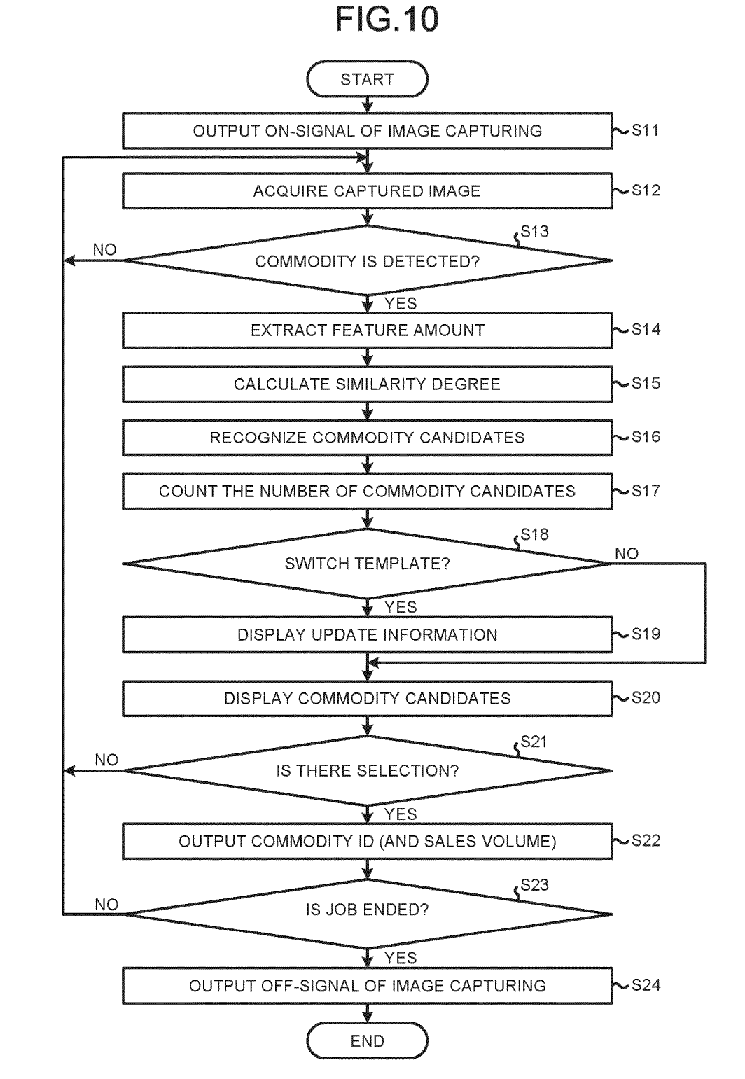

Hereinafter, the operations of the checkout system 1 are described. First, the operations of the commodity reading apparatus 101 are described with reference to FIG. 10. FIG. 10 is a flowchart illustrating the procedure of the commodity recognition processing executed by the commodity reading apparatus 101.

When the processing is started in response to a start of the commodity registration by the POS terminal 11, the image acquisition section 1611 outputs an ON-signal of image capturing to the image capturing section 164 to enable the image capturing section 164 to start an image capturing operation (ACT S11).

The image acquisition section 1611 acquires a frame image (captured image) captured by the image capturing section 164 and stored in the RAM 163 (ACT S12). Next, the commodity detection section 1612 detects the whole or part of the commodity G from the captured image acquired in ACT S12 (ACT S13). If the commodity G is not detected (NO in ACT S13), the process in ACT S12 is executed again.

If the commodity G is detected in ACT S13 (YES in ACT S13), the feature amount extraction section 1613 extracts the feature amount of the commodity G detected in ACT S13 from the captured image acquired in ACT S12 (ACT S14). Then the similarity degree determination section 1614 compares the feature amount extracted in ACT S14 with the feature amount of each registration commodity in the PLU file F1 to calculate similarity degrees therebetween respectively (ACT S15).

The similarity degree determination section 1614 recognizes, in the registration commodities the similarity degrees of which are calculated, the commodity ID of the registration commodity of which the similarity degree is greater than a given threshold value as a commodity candidate. Then, the similarity degree determination section 1614 specifies the registration commodity belonging to the same group as the recognized commodity candidate from the group setting file F2 and recognizes the registration commodity as the commodity candidate (ACT S16).

The commodity candidate indication section 1615 counts the number of the commodity candidates recognized in ACT S16, and selects a template corresponding to the number thereof (ACT S17). Then, the commodity candidate indication section 1615 determines whether or not it is necessary to switch the template being set to the selected template based on the identity between the template currently set and the template selected in ACT S17 (ACT S18).

If it is determined to switch the template in ACT S18 (YES in ACT S18), the commodity candidate indication section 1615 sets the selected template in the commodity candidate indication area A12 after the update information is displayed in the same area A12 for a given time (ACT S19), and then ACT S20 is taken. If it is determined not to switch the template in ACT S18 (NO in ACT S18), ACT S20 is taken.

In ACT S20, the commodity candidate indication section 1615 reads the record of the recognized commodity candidate from the PLU file F1, and arranges it in the arrangement area of the template (ACT S20) to display the template in the commodity candidate indication area A12. Next, the input reception section 1616 determines whether or not the selection of the commodity candidate is received through the touch panel 105, or the keyboard 107 (ACT S21). If the selection operation is received (YES in ACT S21), the input reception section 1616 sets the selected commodity candidate as the determined commodity corresponding to the commodity G, and then ACT S22 is taken. If no selection of the commodity candidate is received in ACT S21 (NO in ACT S21), ACT S12 is taken again.

In ACT S22, the information output section 1617 outputs information such as the commodity ID representing the determined commodity to the POS terminal 11 (ACT S22), and then ACT S23 is taken. In a case in which the sales volume is input separately through the touch panel 105 or the keyboard 107, the sales volume is also output to the POS terminal 11 together with the information representing the determined commodity in ACT S22. If the sales volume is not input, the sales volume “1” may also be output as a default value.

In ACT S23, the CPU 161 determines whether or not the job is ended based on the notification of termination of the commodity registration from the POS terminal 11 (ACT S23). If the job is continued (NO in ACT S23), the CPU 161 returns to the processing in ACT S12 to continue the processing. If the job is ended (YES in ACT S23), the image acquisition section 1611 ends the image capturing of the image capturing section 164 by outputting an OFF-signal of image capturing to the image capturing section 164 (ACT S24), then the commodity recognition processing is ended.

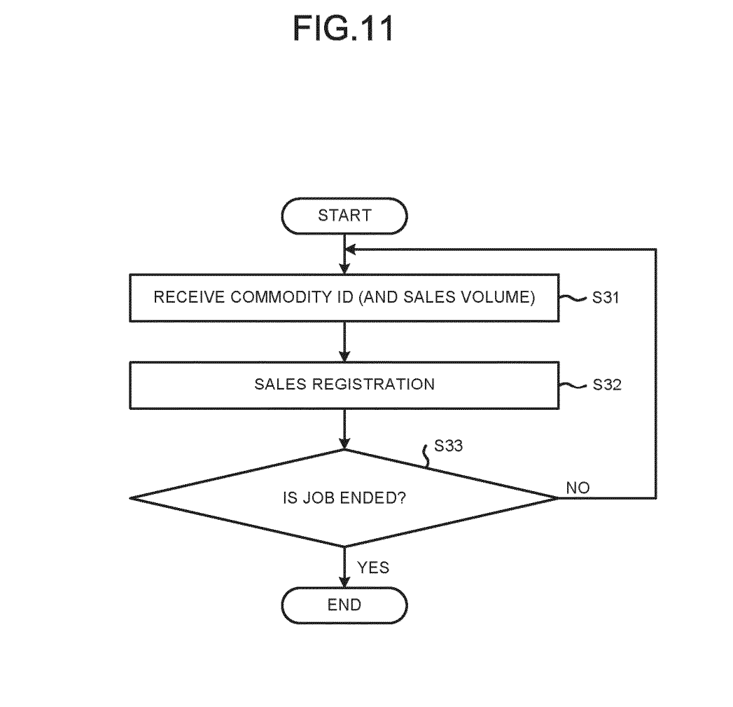

Processing operations of the POS terminal 11 are described. FIG. 11 is a flowchart illustrating the procedure of the sales registration processing executed by the POS terminal 11.

First, when the processing is started in response to the start of the commodity registration according to an operation instruction through the keyboard 22, the CPU 61 receives the commodity ID and the sales volume of the determined commodity output by the commodity reading apparatus 101 in ACT S22 of FIG. 10 (ACT S31). Then, the sales registration section 611 reads the commodity category, the unit price and the like from the PLU file F1 based on the commodity ID and the sales volume received in ACT S31 and registers the sales of the commodity G read by the commodity reading apparatus 101 in the sales master file (ACT S32).

Then, the CPU 61 determines whether or not the job is ended based on the termination of the sales registration according to the operation instruction through the keyboard 22 (ACT S33). If the job is continued (NO in ACT S33), the CPU 61 returns to ACT S31 to continue the processing. If the job is ended (YES in ACT S33), the CPU 61 ends the sales registration processing.

As stated above, in accordance with the present embodiment, the template is switched to display the commodity candidates according to the number of the commodity candidates recognized by the commodity candidate indication section 1615. In this way, the layout for displaying the commodity candidates can be switched flexibly and thus the commodity candidates can be displayed according to the number of the recognized commodity candidates, which can improve the convenience in the display of the commodity candidates. Further, if the template is switched, the update information is displayed for a given time before the template is switched, which can reduce the occurrence of incorrect operation caused by the switching of the template.

While certain embodiments have been described, these embodiments have been presented by way of example only, and are not intended to limit the scope of the invention. Indeed, the novel embodiments described herein may be embodied in a variety of other forms; furthermore, various omissions, substitutions, changes and additions in the form of the embodiments described herein may be made without departing from the spirit of the invention. The accompanying claims and their equivalents are intended to cover such forms or modifications as would fall within the scope and spirit of the invention.

For example, no specific limitation is given to the layout and the size of the arrangement areas in each template as long as they can be changed by the commodity candidate indication section 1615 dynamically. In a case in which such manners (layout and size) are applied, the commodity candidate indication section 1615 may dynamically change the size of the arrangement area according to, for example, the magnitude or grade of the similarity degree.

In the embodiment described above, although the registration commodity belonging to the same group as the commodity candidate recognized through the comparison of similarity degrees is recognized as additional commodity candidate, it is also applicable that the additional commodity candidate is not recognized. In this case, the commodity candidate indication section 1615 selects a template corresponding to the number of the commodity candidates recognized through the comparison of similarity degrees to display the commodity candidates.

Still in the embodiment stated above, the POS terminal 11 is arranged to include the PLU file F1 and the group setting file F2, however, it is not limited to this, and all or part of the PLU file F1 and the group setting file F2 maybe included in the commodity reading apparatus 101.

Further, it is arranged in the embodiment stated above that the recognition of the commodity candidate is carried out in the commodity reading apparatus 101, however, all or part of the functional sections of the commodity reading apparatus 101 may be included in the POS terminal 11.

For example, the POS terminal 11 may comprise the feature amount extraction section 1613 and the similarity degree determination section 1614, while the commodity reading apparatus 101 may comprise the image acquisition section 1611, the commodity detection section 1612, the commodity candidate indication section 1615, the input reception section 1616 and the information output section 1617. In this case, the commodity reading apparatus 101 transmits the captured image, acquired by the image acquisition section 1611, from which the commodity is detected by the commodity detection section 1612, to the POS terminal 11. The commodity reading apparatus 101 receives the result of the commodity (registration commodity) recognized by the POS terminal 11, and indicates the received result as a commodity candidate through the commodity candidate indication section 1615. Further, in a case in which the POS terminal 11 comprises all the functional sections of the commodity reading apparatus 101, the commodity reading apparatus 101 functions as an image capturing apparatus, and the POS terminal 11 carries out the display of a commodity candidate based on the captured image sent from the commodity reading apparatus 101.

Further, in the embodiment stated above, a stationary type scanner apparatus (commodity reading apparatus 101) is used, as an example, however, it is not limited to this, and a so-called handy type scanner device connected with the POS terminal 11 may be employed instead.

Still further, according to the embodiment stated above, in a checkout system 1 consisting of the POS terminal 11 and the commodity reading apparatus 101, the present invention is applied to the commodity reading apparatus 101, however, it is not limited to this, and it may also be applied to a single apparatus comprising all the functions of the POS terminal 11 and the commodity reading apparatus 101, or a checkout system constituted by, for example, connecting the commodity reading apparatus 101 and the POS terminal 11 shown in FIG. 1 in a wired or wireless manner. As a single apparatus comprising all the functions of the POS terminal 11 and the commodity reading apparatus 101, a self-checkout apparatus (hereinafter referred to as a self-checkout POS) arranged and used in a store such as a supermarket and the like is known.

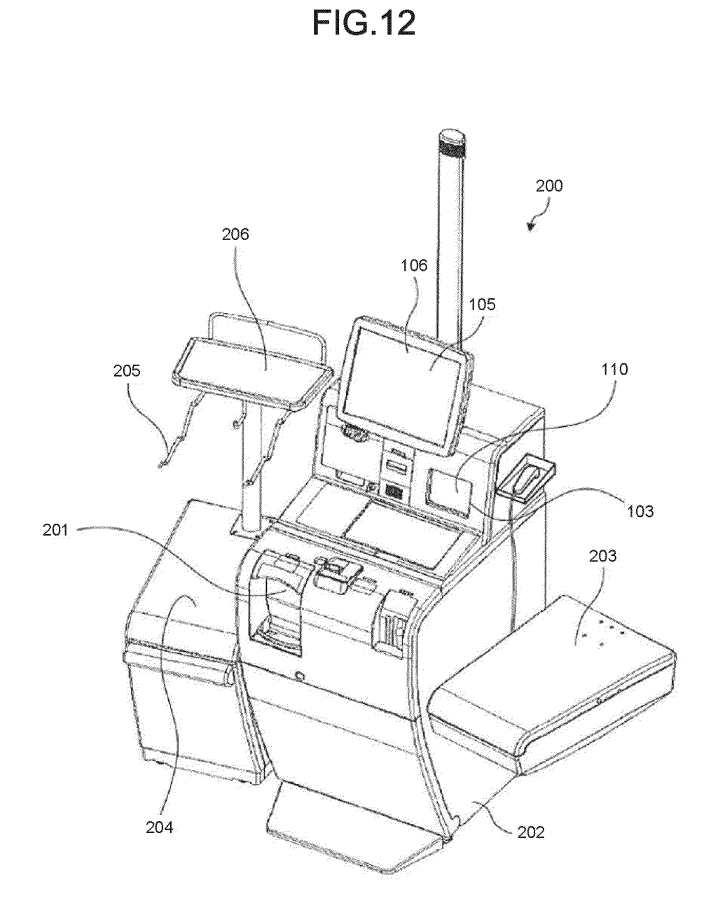

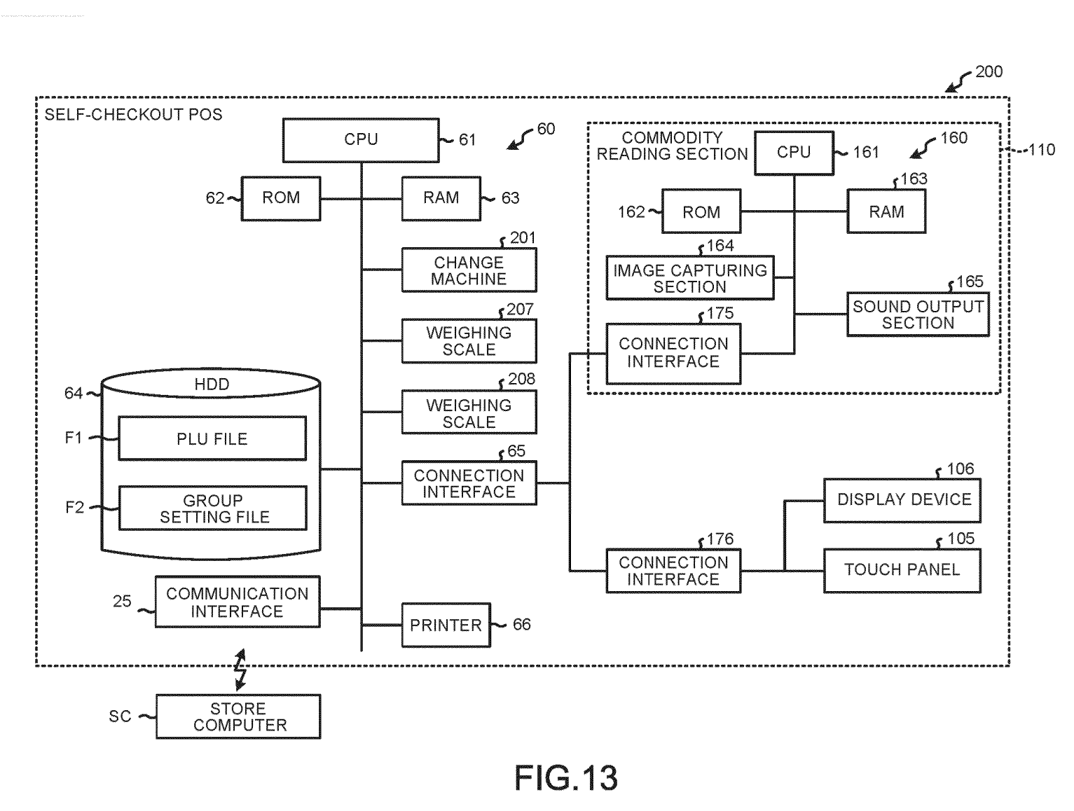

FIG. 12 is a perspective view illustrating the external constitution of the self-checkout POS 200, and FIG. 13 is a block diagram illustrating the hardware constitution of the self-checkout POS 200. Hereinafter, the same numerals are applied to the components similar to that in FIG. 1 and FIG. 2, and the detailed descriptions thereof are not repeated.

As shown in FIG. 12 and FIG. 13, a main body 202 of the self-checkout POS 200 comprises a display device 106 having a touch panel 105 on the surface thereof and a commodity reading section 110 which captures a commodity image to recognize (detect) the category of the commodity.

The display device 106 may be, for example, a liquid crystal display. The display device 106 displays a guidance screen for providing customers with a guidance for the operation of the self-checkout POS 200, various input screens, a registration screen for displaying the commodity information read by the commodity reading section 110 and a settlement screen on which a total amount, a deposit amount and a change amount are displayed for selecting a payment method.

The commodity reading section 110 captures a commodity image by the image capturing section 164 when the customer holds the code symbol attached to a commodity in front of the reading window 103 of the commodity reading section 110.

Further, a commodity placing table 203 for placing the unsettled commodity in a shopping basket is provided at the right side of the main body 202, and, at the left side of the main body 202, a commodity placing table 204 for placing the settled commodity is provided. A bag hook 205 for hooking a bag for placing the settled commodities therein and a temporary placing table 206 for placing the settled commodities temporarily before the settled commodities are put into a bag are also provided at the left side of the main body 202. The commodity placing tables 203 and 204 are equipped with weighing scales 207 and 208 respectively, and are therefore capable of confirming whether or not the weight of commodities is the same before and after a settlement.

Further, a change machine 201 for receiving bill for settlement and discharging bill as change is arranged in the main body 202 of the self-checkout POS 200.

In a case in which the present invention is applied to the self-checkout POS 200 having such constitutions as described above, the self-checkout POS 200 functions as an information processing apparatus. Further, a single apparatus comprising the functions of the POS terminal 11 and the commodity reading apparatus 101 is not limited to the self-checkout POS 200 having the above-constitutions and it may be an apparatus without having weighing scales 207 and 208.

Further, in the embodiment above, the programs executed by each apparatus are pre-incorporated in the storage medium (ROM or storage section) of each apparatus, however, the present invention is not limited to this, the programs may be recorded in a computer-readable recording medium such as CD-ROM, flexible disk (FD), CD-R, DVD (Digital Versatile Disk) in the form of installable or executable file. Further, the storage medium, which is not limited to a medium independent from a computer or an incorporated system, further includes a storage medium for storing or temporarily storing the downloaded program transferred via a LAN or the Internet.

In addition, the programs executed by each apparatus described in the embodiments above may be stored in a computer connected with a network such as the Internet to be provided through a network download or provided or distributed via a network such as the Internet.

Alternatively, the programs mentioned in the embodiments above may be incorporated in a portable information terminal such as a mobile phone having a communication function, a smart phone, a PDA (Personal Digital Assistant) and the like to realize the functions of the programs.

What is claimed is:

1. An information processing apparatus, comprising:
an image capturing module configured to photograph a commodity to capture the image of the commodity;
an extraction module configured to extract a feature amount from the image captured by the image capturing module;
a calculation module configured to compare the feature amount of each commodity registered in a dictionary with the feature amount of the commodity extracted by the extraction module to calculate a similarity degree therebetween;
a recognition module configured to recognize a commodity of which the similarity degree is greater than a threshold value as a commodity candidate within the commodities registered in the dictionary; and
a display control module configured to switch information representing the commodity candidate according to the number of the commodity candidates recognized by the recognition module to display it.

2. The information processing apparatus according to claim 1, further comprising:
a selection module configured to select, from a plurality of templates respectively including different numbers of arrangement areas, a template according to the number of the commodity candidates recognized by the recognition module; wherein
the display control module displays information indicating the commodity candidates in the template selected by the selection module.

3. The information processing apparatus according to claim 2, wherein
the display control module displays a message indicating that the template is being updated for a given time at that time at which the template currently displayed is switched to the selected template.

4. The information processing apparatus according to claim 2, wherein
the arrangement area is capable of being changed at its size, and
the display control module changes the size of the arrangement area according to the value of the similarity degree of the registered commodity.

5. The information processing apparatus according to claim 1, wherein
the recognition module recognizes a commodity as a candidate of the commodity from the commodities registered in a dictionary and recognizes a commodity, which is registered in a dictionary and belongs to the same group as the commodity recognized, as a candidate of the commodity.

6. An information processing method, including:
photographing a commodity to capture the image of the commodity;
extracting a feature amount from the image captured;
comparing the feature amount of each commodity registered with the extracted feature amount of the commodity captured to calculate a similarity degree therebetween;
recognizing a commodity of which the similarity degree is greater than a threshold value as a commodity candidate within the commodities registered; and
switching information representing the commodity candidate according to the number of the commodity candidates recognized to display it.
